(19) United States
(12) Patent Application Publication
(10) Pub. No.: US 2015/0052209 A1
(43) Pub. Date: Feb. 19, 2015

(54) SYSTEM AND METHOD FOR STRUCTURED MESSAGE ENTRY FOR USE IN SOCIAL MEDIA PLATFORMS

(71) Applicants: Mikhail Vorotyntsev, New York, NY (US); Dmitriy Khmaladze, Hudson, OH (US)

(72) Inventors: Mikhail Vorotyntsev, New York, NY (US); Dmitriy Khmaladze, Hudson, OH (US)

(21) Appl. No.: 14/209,098

(22) Filed: Mar. 13, 2014

Related U.S. Application Data
(60) Provisional application No. 61/781,615, filed on Mar. 14, 2013.

(51) Int. Cl. H04L 12/58; H04L 29/06

(52) U.S. Cl. CPC H04L 51/32; H04L 65/403
USPC 709/206

(57) ABSTRACT

A system for implementing data postings in a social media platform is provided having an interface configured to allow users to receive messages from and to post messages to the system. A processor provides a plurality of structured data tags for use by the users, where the structured data tags have at least one data field for correlating at least one structured data entered in conjunction with the structured data tag. The system in configured to receive a plurality of communications from the users which include at least one structured data tag and at least one correlated structured data.

### RELATED APPLICATIONS

This application claims the benefit of priority from U.S. Provisional Patent Application No. 61/781,615 filed on Mar. 14, 2013, the entirety of which is incorporated by reference.

### BACKGROUND

1. Field of the Invention

The present invention relates to a system and method for structured data entry and categorization. More particularly, the present invention relates to a system and method for structured data entry and categorization in a social media data entry setting.

2. Description of Related Art

Current social media platforms include large volumes of unstructured information posting in free form. This information is hard to semantically process/quantify/correlate by computers because it is either a free form text, image/video and not readily “understandable” by existing computational platforms.

In many cases, social media platforms include a message classification system to help semantically process/quantify/correlate such unstructured information postings using hashtags (e.g. #event, #feeling, #identifier, etc. . . . ). However, such classifications systems are user correlated meaning they typically operate by the user posting a message and then self correlating to any form of hashtag of their own creation. Although many people may use similar hashtags to identify similar postings, because of the free form, two related postings may be entered under different hashtags by different users. As an example, a first user at a concert at Madison Square Garden may enter a posting to their social media page under #MadisonSquareGarden but another user at the same location may post and then correlate it to a hashtag #MSG, or #msg or #MSGNYC etc. . . .

In this context, because of the absence of structure such prior art systems have no way to automatically attach data that corresponds with the tag, particularly across multiple users as there is no set/defined correlation between the exact character used for the tag and the data contained in the associated message. For example, in prior art systems, if a user were to post and use a tag “#hotweather” the corresponding data in such a post could literally be anything the user wanted (which may or may not even relate to hot weather) and may not even include temperature or location.

Another issue with current internet sites as well as social media sites is that they have their users conditioned to think of life/events in terms of current status:
in time and space: Foursquare™,
directions in Google™ maps, (including nearby friend locators)
emotionally & informationally: Facebook™, Twitter™ etc.
objects/devices: Amazon™ (delivery status updates), Nest™ (what is the temperature in my house) etc. . . . .

There exists an unfulfilled need to provide structured data entry into social media applications so that various related posts can be more readily correlated with one another. Moreover, there exists a need for a social media resource that provides users with their current status based on past entries (such as structured entries).

### SUMMARY OF INVENTION

The present invention provides a new and novel system and method for structured data acquisition, classification and analysis as facilitated by various existing and future social data sources, such as (but not limited to) —social networks (i.e. Facebook, Twitter, etc.), gadgets/devices (i.e. personal health equipment, pedometers, auto trip computers, mobile apps, etc.).

To this end, the present arrangement makes use of structured data tags for the collection of structured data, associated with the tags, where the tags facilitate the collection of pieces of text formatted per well-understood grammatical syntax rules. The present arrangement is further configured to provide a semantic taxonomy network/hierarchy that works as a categorization system that defines the logical/semantic interconnections between different aspects of life—laws of nature/science/social/emotional and other human and natural aspects (i.e. weather, health, satisfaction level, consumer sentiment, etc.) as supplied for analysis in the form of the structured data tags and the associated structured data collected therethrough.

Among other elements, such a system provides at least three features not found in the prior art social media systems.

Firstly, the present system provides a media platform that includes structured data and data tags for the purpose of automated correlation and analysis. Such an arrangement, finds correlations between related information as well as not-directly-related information. The system can also perform statistical analysis on user messages provided in this context. The system further supports a semantic data taxonomy so gathered data can be interpreted in a pre-defined context of meaning. This arrangement of structured data and data tags may be further used to gather such structured input from users and other sources, giving users ability to view that information as time-series.

Additionally, in the context of structured data entry, the present system provides a social media platform that allows the users to communicate using gestures. For example, a user may be enabled to use gesticulations to express feelings/emotions/etc. . . . and perform social interactions using body movements on various devices including mobile devices and phones. The system contemplates creating a gesticulation alphabet that uses a structured data tag approach to communicate specific meanings via data/social platforms.

Another element of the present system is to provide audio/voice-based controllers, applicable in gaming, social interactions and art creation. The present system can use real-time signal analysis for the purpose of conversion of sound into “action alphabet”—such as (up/down, left/right, hot/cold, values etc. . . . ), which can be used as vocal gesticulations to be entered in conjunction with the system's structured data tagging on social platforms.

To this end the present arrangement provides for a system for implementing data postings in a social media platform having an interface configured to allow users to receive messages from and to post messages to the system. A processor provides a plurality of structured data tags for use by the users, where the structured data tags have at least one data field for correlating at least one structured data entered in conjunction with the structured data tag. The system in configured to receive a plurality of communications from the users which include at least one structured data tag and at least one correlated structured data.

### BRIEF DESCRIPTION OF THE DRAWINGS

The foregoing aspects and many of the attendant advantages of this invention will become evident to the reviewer as the included drawings become better understood with respect to the details provided, wherein:

FIG. 1—illustrates an exemplary system diagram, in accordance with one embodiment;

FIG. 2—illustrates an exemplary post from the system of FIG. 1 with associated data fields, in accordance with one embodiment; and

FIG. 3—illustrates a widget form for entering a post on system 10, in accordance with one embodiment.

### DETAILED DESCRIPTION

In accordance with one embodiment of the invention, the present arrangement as described herein provides a data collection system and architecture that includes structured data and data tags for the purpose of automated correlation and analysis.

To this end, the present system (hereinafter referred to as “system” or “the system”) has the ability to receive and post social media postings, that among other things, can be used to denote status health-wise, fitness-wise, mood-wise, safety/security-wise, finances-wise, career-wise, pets' and belongings' status-wise, etc. Large volumes of publicly-available data are analyzed and put to use immediately so that the system's usefulness—rather than being driven by the eventuality of network effects arising from a critical mass of users—is there from the beginning.

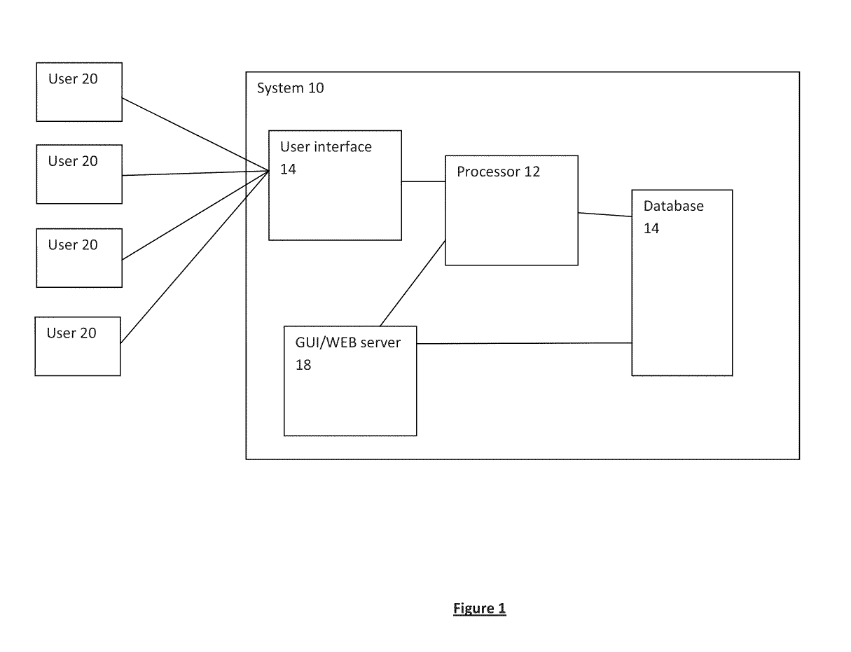

To this end, as shown in FIG. 1, an exemplary data collection and presentation system 10 is provided with a processor 12 for implementing the various features described below as well as a database 14 for maintaining the storage of the various social media message/content. System 10 also maintains an interface 16 for allowing users 20 for communicating with system 10 as well as other users 20 through system 10. System 10 further maintains a GUI/web interface 18 configured to allow direct web-based access to system 10 for any ancillary connectivity required by users 20, such as initial review, download of system applications, updates, system news etc. . . . .

It is noted that the present system 10 is primarily a system for the collection of structured data for the use in a semantic taxonomy network/hierarchy that works as a categorization system that defines the logical/semantic interconnections between different aspects of life. Such a system 10 may be implemented in many different ways. As a first example, system 10 may be implemented as an independent web/social media site. As a second example, system 10 may be implemented as a functional unit of an existing social media site, as an additional component to such sites. As a third example, system 10 may be implemented as a stand-alone third party system that interacts with existing web/social media sites, as an additional feature compatible with, but not necessarily part of such sites. The below described features of system 10 may be implemented in whole or in part in the context of any one of the above examples or in any other workable arrangement that could benefit from such structured data collection.

Moreover, it is understood that system 10 as shown in FIG. 1, with the various components is considered exemplary and non-limiting. The features of the present invention may be implemented on various system architectures and in other contexts provided it otherwise utilizes the features of structured data tags.

Such a system 10 as shown in FIG. 1 gathers structured input from individual users 20 and other sources (also structurally—users 20). As explained in more detail below, among other features, the structured data tags of the present arrangement give users 20 the ability to view their own postings as time-series and find correlations between related, as well as not-easily-related information.

As noted in the Description of Related Art section above most present social media systems are time-based. The present system 10 on the other hand allows users to post/chat messages using structured (i.e. pre-categorized) tags, as opposed to free text, in the temporal (time-related) plane as explained in more detail below.

Information structuring allows system 10 to make sense semantically of the social conversations/presence and draw logical/statistical inferences based on provided input and correlation of provided inputs from multiple sources/users 20.

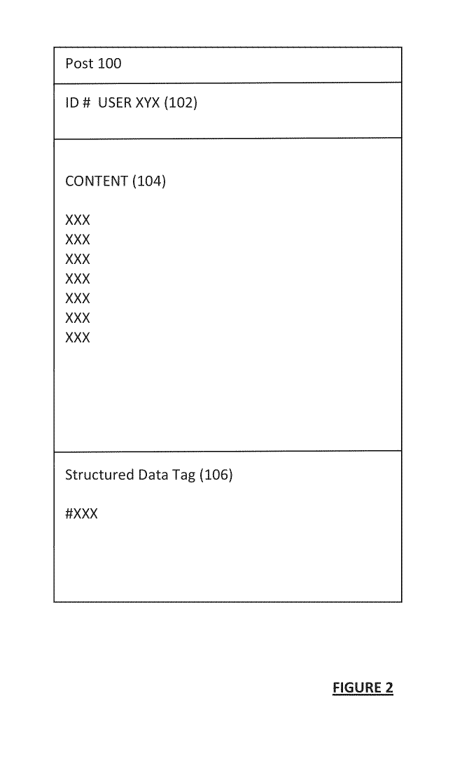

In one embodiment, FIG. 2 is an outline structure (data fields) of a social media posting 100 that exemplifies a typical input to system 10. Posting 100 generally includes an identifier 102 such a name or handle of user 20 that correlates with a user account at system 10. Posting 100 also includes some correlated content 104 which can be any one of a text posting, a picture or any form of alphanumeric data, essentially the content of post 100. Posting 100 further includes at least one structured data tag 106. As exampled in more detail below, structured data tag 106 functions similar to prior art social media systems in that posts/content 104 having the same data tag are associated in system 10. However, unlike prior art systems and as explained in more detail below, users 20 do not simply apply/write their own data tags for their posts 100. Rather, system 10 pre-authorizes users 20 for a wide range of structured tags 106 so that data/content 104 can be automatically correctly correlated with the previous posts of the same user 20 using the same structured tags 106 as well as other posts 100 of users 20 using the same structured tags 106.

It is understood that posting 100 shown in FIG. 2 is an exemplary post 100 for system 10, but is not considered limiting. Posts 100 can include additional fields as required, multiple copies of fields etc. . . . without deviating from the concept of the invention.

As an example of post using, a structured hash tag or data tag 106 may be as follows:
John (102): I feel good today (free text) #bpressure (106)=120/70 (104)

Examples of how such structures and categories for structured tags 106 are developed by system 10 and users 20 and how posts 100 under such tags 106 to better organize and observe real time social media trends is explained in more detail below.

As an initial overview of the present system 10 the resolution of such structured tags 106 would be performed by system 10. There are at least two differences between existing free form hashtag-based approach used in contemporary social media sites and structured tag 106 based system 10.

Firstly, structured data tags 106 adhere to strict grammatical rules and thus have a defined syntactical composition. This facilitates an efficient and 100% deterministic parsing of correlated content 104 by system 10. Structured data tags 106 generally are composed of segments which are delimited by punctuation symbols such as ‘,’ and ‘=’. Because of the strict structure/grammar that each tags 106 complies with, it is possible to feed tag data 104 into a DFSM (Deterministic Finite State Machine) housed in processor 12 that would yield a predictable (as opposed to parsing of a free-form text) AST (abstract syntax tree). In other words, the parsing of correlated data 104 does not require an analysis of free form text of a post in order to identify its syntax.

Secondly, system 10 described herein is purposed to perform a semantic analysis of the AST (abstract syntax tree) obtained during parsing. The whole idea of semantic analysis becomes possible because of:
a. Predictable nature of tag structure 106 (hence AST)
b. Classification/taxonomy mechanism that system 10 provides to establish a “meaning link” between otherwise non-obviously influential indirect fact groups (i.e.: weather and human personal mood)

For example, the following is an exemplary analysis of structured content 104 provided to system 10 in the form of data linked to structured tags 106. Every tag content/data 104 is fed through a chain of processors (i.e. within processor 12) —a typical computer language compiler design:
(1) “bp=120/70”->(2)[LEXER]->(3)[PARSER]->(4)[AST]->(5) semantic analysis
(1) —the tag content fed as a single string i.e. “bp=120/70” Here the system recognized tag 106 is “bp=” and the correlated data 104 is “120/70.”
(2) —LEXER scans input characters paying attention to delimiters and turns the string into a series of tokens: {TAG NAME=“BP”}, {EQUALS}, {integer value=120}, {DIVIDE}, {integer value=70}
(3) —PARSER understands and expects a certain sequence of tokens as define by the tag name, thus it can form a DFSM to obtain an
(4) AST (Abstract Syntax Tree) for the tag:
BLOOD_PRESSURE(UPPER_BOUND=120, LOWER_BOUND=70);
(5) the semantic analysis is performed over an AST. The nodes of the tree are now looked-up in a system wide taxonomy/classification network. Now many inferences are possible. For example, system 10 now can “understand” that user 20 posted a post 100 having a tag 106 about his/her “BLOOD PRESSURE.” System 10 can match the data 104 (measurements) against the reference ranges of normal blood pressures for humans and arrive at some conclusions, i.e. upper number over >120 indicates a hypertension which is a HEALTH RISK, which is a NEGATIVE factor for the overall human health etc.

The entry of posts 100 having tags 106 and correlated data 104 may be purely textual, i.e. user 20 can simply type a free from post 100 that among other free text also includes a tag/data 106/104 (continuing the example above) “Hello, my blood pressure is #bp=120/70”. Alternatively, posts 100 having tags 106 and correlated data 104 may be entered purely using a graphic widget.

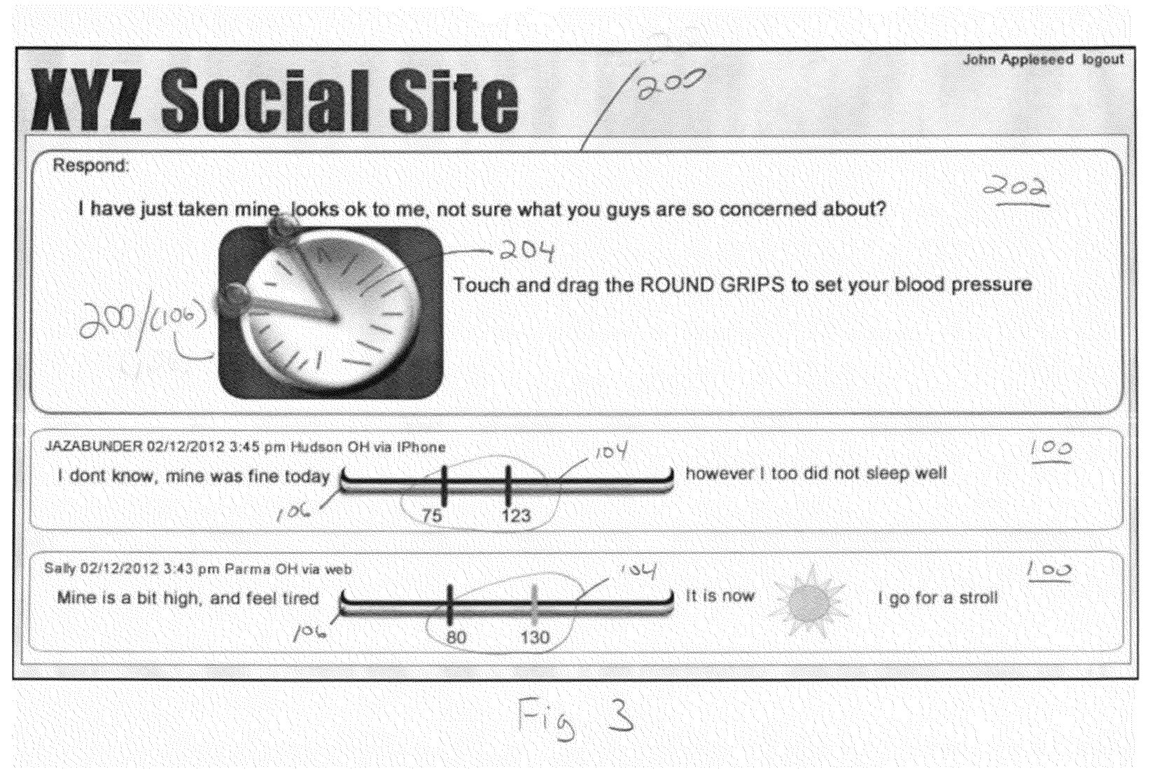

For example, as shown in FIG. 3, a widget 200 can be in the form of a miniature portions of a larger GUI (graphical user interface) 202 that facilitate the composition of post 100 having a structured tag 106. For example, instead of typing “#bp=120/70” a user would select widget 200 that includes a “barometer” looking icon 204 and touch the dial. The entered touch data 104 can be automatically inserted as a tag/data 106/104 into a post 100. Such widgets 200 can be used not only for entry of posts 100 but also for visualization of tags 106.

Another feature of structure tags 106 in system 100 is their ability to allow system 10 to perform adaptive parsing. In terms of function analysis in mathematics—every tag 106 is a function of a either fixed or flexible arity, fully or partially variadic. In other words, the structure of every tag 106 depends on the name of tag 106, thus system 10 uses the appropriate PARSER to extract the specific AST (Abstract Syntax Tree) for every particular tag 106. In terms of BNF grammar—structured tags 106 share the same LEXER/delimiters but the BNF (Backus-Naur Form) spec is different and depends on tag 106 name. In other words, this can be exemplified like so: the “BLOOD PRESSURE” tag 106 (“bp=”) has two components to it (systolic and diastolic), however the “WEATHER” tag may have many optional parameters (humidity, temperature, wind direction, atmospheric pressure). System 10 would know that data 104 with tags 106 for “BLOOD_PRESSURE” expects one data structure for data 104, posts 100 are entered with data 104 under a tag 106 for “WEATHER,” system 10 knows to expect another precise data structure for data 104.

The following Table 1 is a showing of some exemplary structured data tags 106 and the associated form for the structured data 104 that is used by system 10.

TABLE 1

| Structured tag (106) | Related Content form (104) |
|---|---|
| #bp{ressure} | [{systolic=}int/{diastolic=}int] example: |
| | #bp=120/70 |
| | #bpressure=diastolic=70/systolic=120 |
| #w{eather}\|#w{ette | [{t{emp{erature}}=int{F\|C}}...] example: |
| r} | #w:t=65f,clear,rising |
| | #wetter:t=27c,regnet (German version) |
| #mood | #mood=great |
| | #mood=5star |
| | #cat.mood=super (mood of my cat as |
| | defined by REL=”cat” segment so tag name) |
| #rode | #rode=25min |
| | #rode=10km,bike |
| #pulse | #pulse=145,treadmill |
| | #pulse=62,resting |

It is noted that the full list of structured tags 106 supported by system 10 is obviously too long to list in full. It is contemplated that system 10 will have a series of initial tags 106 that are available to all users 20. Thereafter, system 10 may generate and/or accept user generated tags 106 to keep up with trending topics, where system 10 will adopt new tags 106 based on certain types of content that is trending and offer such tags 106 to users 20 for new posts 100.

As one exemplary process for generating new structured tags 106, system 10 administrators can simply draft new tags 106 as desired. As another exemplary process, new tags 106 can also be created in system 10 though an open-source, user 20 driven, vetting process. A user 20 may create any tag 106 they want, but if that tag does not make sense the rest of the user 20/admin (community) they can vote it down or delete it. The very nature of taxonomy/interlinking of tags 106/meanings implies that the tag authoring is a complex process so users cannot just create a tag 106 without much research and cross-linking of tags 106 meaning. In other words, the construction of the classification network of tags 106 is system 10 is a collaborative peer-reviewed effort. As noted above, as an example, system 10 is pre-populated with a few hundred key tags 106 that are properly classified/interlinked into a semantic network as the result of much research in the applicable fields. Such tags 106 are available for use by users 20 either in total or in downloadable segments (so users can have a manageable number of tags 106) such as health tags 106, etc. . . .

Using such above described posts 100, system 10 can further perform analysis on such posts 100 and
organize posts 100 under certain data tags 106 into taxonomy so semantic traversal can be made in future (i.e. “#head ache=meta tag BAD);
manages user privacy—who can decipher what data tags 106 for a particular user 20;
identify correlation of otherwise disparate facts (i.e. posts under #StorminIowa correlated with #headache increasing in the same geographic area.

Such structured data tags 106 can be used by system 10 to collect structured posts 100 based on user gestures (explained in more detail below), indignation/frustration (e.g. indignation while getting subpar service at a car dealer) level, mood, medical vitals, financial, success levels all of which will be correctly entered in a structured form, but otherwise similar to existing social media models. But rather than time based standard unstructured tags, the present structured tags 106 would be pre-categorized by system 10 so that when various users 20 post under such structured tags 106, system 10 is able to easily recognize them as such.

(e.g. Use Case 1: Public gathering—people start to shake their phones using the below explained gesticulation feature as a form of entering a content 104 Yay/Nay within a structured tag 106 entry that is simply #postivenegative—when such posts 100 are posted to the system, for example one thousand (1000) users 20 at one geographic location, they all enter system through an identical structured data tag 106, in this case with only two possible forms for the content 104, so that system 10 can generate a “heat map” as to the feelings of a large crowd at a particular location.

Using the above described structured data tags 106, system 10 can acquire a large quantity of structured data quickly, which can then be subjected to semantic analysis/correlation without excessive work in initial categorization (as the entries were all pre-correlated).

In the context of such structured data acquisition, the following are some exemplary definitions:
source—a person/user 20 representing any entity that can report data facts (i.e. people, groups, communities, geographical regions, countries, business entities etc.)
fact—a type of recorded fact (i.e. “Air Temperature”, “Blood Pressure”)
records/content 104—a data record of a particular type/fact reported by data source as of particular time a record is a datum of the following structure: {USER_ID, TIME, FACT_ID, FACT_VALUE}
structured fact tag 106—a convention/protocol that would allow users to exchange structural/computer-understood messages on social mediums. It has the following form:
   #rel.fact_id=fact_value—

Such structured tags 106 are easily segregated by host applications for hyperlinking as they cannot have spaces in them.

A single social conversation message may have more than one fact tag. For example in the above example (#rel.fact_id=fact_value—
the rel is an optional segment that qualifies what this record relates to. In case then the fact relates to the source (self) it can be omitted.
the fact_id is the unique identifier of a fact of interest, unique in “the system 10”.
the fact_value is a fact_id-dependent data in a format understandable by the fact pointed to by fact_id.

Turning to an example of a post 100 on the present social media system 10, using the above described structured data tags 106, the following is another exemplary social conversation with the structured fact-tags 106 that ultimately is also monitored by system 10 as “structured data” for further analysis by the system:
JackP2801 12/10/2012 2:13 pm via Web:
My friends, #niacin works great #bp=128/85 thats a 10% drop in less than a week, however I am kind of underweight #w=150 lb for my #h=5′11″ maybe because weather is nice, its warm #weather.temp=75 f today
Sarah8900 12/10/2012 2:01 pm via iPhone:
Did anyone try #niacin to knock blood pressure? I am sitting in this range #bp=145/110 for days!

The structured tags 106 are #niacin, #bp=, #w, #h, #weather.temp. The loose text is all part of content 104. The entries after the “=” are structured forms of content 104, directly related to the preceding structured tag 106 (with limited entry parameters)

In another embodiment of system 10, structured facts/content 104 associated with structured tags 106 received by system 10 as a result of the many user's 20 sending/entering messages using structured data tags 106 are in turn organized in a forest of taxonomy trees that are interconnected, thus forming a network of semantic meanings. Because of structured organization of fact types we can now relate facts using their meanings.

For example, system 10 can on its own collect content 104 from various posts using combinations of structured tags 106 related to “#ill health,” “#bad”, or “#deficit” and “#headache” as well as “#medicalsymptom,” and “#health issue.” Since the structured portions of content 104 are limited to be associated with specific pre-contextualized structured tags 106, system 10 can know that a single social post with “#headache” tag by some user 20 can be correlated as a report of a medical symptom, something bad or negative and health concern all at the same time without needing to parse unstructured content or tags as in the prior art. System 10 can in turn correlate “bad”/“negative” things reported in the geographical area or social strata (interest group) or other such formats.

Such automatic correlation may work by monitoring standard deviation of samples, and functions which are defined empirically (lookup function based on record samples), their derivatives of first and secondary orders and identifying direct and transitive dependencies.

In another embodiment, structure tag 106 privacy is provided by means of ciphering. Any user 20 may message openly using obfuscated/ciphered tag like so:
JackP2801 12/10/2012 2:13 pm via Web:
My friends, #niacin works great #!X78x3aza thats a 10% drop in less than a week, however I am kind of underweight #!b8x6a9k9dhw87e for my #!h3uf9e92

Each obfuscated structure tag 106 which also represents a hyperlink to a private store (e.g. database 14 or third party storage) hosting encrypted data behind tag 106. The link complies with an open API specification that allows a private store provider to implement custom ciphering logic required for decoding tag 106.

### Example

user A posts 100 some private fact record so when user B tries to browse the record they need to have A's key in his key chain maintained by system 10 records which was granted by original owner. User B cannot forward grant to anyone else.

Having summarized some of the basic features of the present structured data tags 106 the following is a list of possible uses for such tags 106 within system 10 to provide users 20 not only the ability to post temporal content 104, but also to use structured tags 106 to obtain, post and review historical content 104 in a formal structured environment so that such historical review is in an easily understandable, searchable and contextualized manner:
a structured diary in which a user 20 reports their status/events in life—for people, families, pets etc. . . . ;
a personal diary that structures the input, unlike the popular social sites now—meaning that information is being entered per certain predetermined criteria, such as, say, vital signs, mood, goals (e.g. Today I'd like to exercise for 30 minutes during lunch, or, Today I'd like to avoid eating at this grease joint), all via structured tags 106

Such structured data tags 106 can be used to correlate the life of a user 20 with any discrete, identifiable and recordable fact, concept, event, thought, idea, sensation, opinion or aspect of the world, starting from the personal, e.g. tracking how much beer they have drunk in their life, etc. . . . , to the quotidian, e.g. the weather, daily news, to the global and cosmic, e.g. galactic and universal (supernovae, comets flying by Earth, solar flares, meteor showers), geopolitical (revolutions, invasions, wars), human/manmade (health/mood/activity; accidents, spills, explosions; reported criminal activity; massive gatherings of people for a purpose or cause; missions to space and other planets, etc. . . . ) and natural (earthquakes, floods, tsunamis, animal species dying off suddenly, rivers drying up precipitously) events. In each case, these include structured content 104 associated with structured data tags 106 making such events easily searchable.

The present system 10 allows a user 20 to browse their status as a human being vs. time and across space, in relation to others and vis-à-vis the state of the world within the context of the structured data. It's about a user getting to themselves, their life, who they are, and getting to know the world. Unlike prior art systems the present system 10 does not need to guess or use metrics to pull such data from unstructured postings, but instead has instantly and accurately compiled data 104 for mining.

In another embodiment, system 10 may be implemented similar to financial planning, only for the life of a user 20 (life planning). Just as people browse their financial portfolios, system 10 allows them to browse their life (including the actual financials) health, bodily events (aches/cramps/twinges, arousal: physical or mental; depression, etc. . . . and then correlate the things with whatever else, including outside events, like the weather, news, life events: graduations, wedding, births, deaths, reincarnations, etc. . . . . Because each post 100 of user 20 includes structured content 104 that are associated with structured tags 106, all prior posts 100 of a user 20 can be reviewed and searched on a structured tag 106 basis, tag by tag or as correlated to related/other tags.

Using the above structured data tags 106, the following is a list of practical applications that employ structured data tags 106 as well as structured data 104 (i.e. data/messages posted by users under structured tags 106).

Health Tracking
Users 20 will track different aspects of their health, such as weight and aches/pains. They'll be able to review cycles in their health conditions.

Allergy Meter
Users 20 will record their allergy stats correlated to the pollen count, humidity/dryness and wind conditions. They'll be able to see the historical status of their allergies.

Mood/Happiness/Stress/Sex-Drive Metering
Users 20 can track aspects of their mood, and have access to reports showing their happiness/mood/stress state. Global reports show world regions ranked by people's degree of happiness, sex drive, etc. . . .

Social Networking
Users 20 are able to select friends and see/share taxonomy interests. They can see how their friends are doing with regards to their mood or other facts tracked by them in system 10.

Interest Groups
Users 20 can join interest groups within system 10 that have defined factual goals. Users 20 will be able to see their own progress and the progress of group members in achieving the preset goals.

Competitions
Users 20 can be able to create competitive challenges based on the data belonging to similar taxonomy categories. Users 20 can create competitive events, where they would invite others to compete in specific categories, such as who covers the greatest distance on their monthly hiking trips, or who drinks more beer, or who snores louder at night in a given time interval. All data for such competitions can be entered in a structured form of content 104 under a competition specific structured tag 106

Personal Avatar Goal Tracker
Users 20 can set up an avatar profile with certain metrics set as the goals. The avatar can track a user's performance (e.g. weight or distance traveled or mood status based on structured content 104 from posts 100) against its own threshold metrics and remind the user (tamagochi-style) about his/her progress in order to stimulate the accomplishment of personal goals.

Fantasy Sports/Worlds
Taking the idea of an avatar further, system 10 offers the option of entering data facts for imaginary/fantasy/virtual creatures, events, sports, worlds etc and having it correlate with real-world data facts as well as other fantasy data. For example, fantasy football league statistics could be correlated with real-world weather or the weather on Mars during an extra-terrestrial exhibition game (with both players and spectators in astronaut suits); the scores in an imaginary ping-pong tournament between the characters of StarTrek™ could be correlated with the height/arm reach and muscle-contraction speed of these characters as well as the corresponding characteristics for Earth-bound champion table-tennis players. etc. . . .

Event Blog with Non-Textual Characteristic Attachments
Users 20 may have a historical diary of events with annotations associated with facts tracking his/her emotions, physique and other factors.

Cloud Timer
Users 20 have stopwatches and timers measuring timed events and storing them in system 10, in association with particular facts, e.g. a phone-app stopwatch is used to time a daily one-mile run that would also keep track of the concurrent weather conditions.

Agents
When recording a fact via structured content 104 with a structured tag 106 in a post 100, user 20 can configure such content 104 to link to other structured content facts 104, so that system 10 can either creates snapshots of these links and associates them with the user's fact record, or just has that reference for correlation purposes only.

### Example 1

Whenever user 20 log/posts the start/end time of a walk to a train station, system 10 automatically logs for you pertinent facts such as: weather conditions (wind, temperature, snow, rain, etc); real-time train schedules, delay/construction reports, police activity, etc. . . .

### Example 2

User 20 could set up a completely different agent, one that links their schedule for the day with, say, solar flares, magnetic storms, tidal charts for your local waterway, planetary positions and your birth chart (horoscope), so that you could decide whether the day ahead is an auspicious one for the tasks you have in mind.

Lucid Dream Tracker
Users 20 can log significant dream. This may include either lucid dream experiences or predictions. User 20 can later analyze the meaning of these predictions.

Psychic/Fortune Teller
Users 20 with psychic abilities can record the facts of their visions regarding global events. A global correlated map of such predictions can show users 20 the potential hot spots or epicenters of negative energy.
MD Office Portal—a dedicated web portal for medical specialists (e.g. cardiologists, gastroenterologists, orthopedists). Users 20/Patients can record facts related to their care plan as provided by the attending physician; for example, a diabetician's plan will default to a series of facts related to the ailment in the patient's profile.

Each of the above examples, are use examples enhanced by the use of structured data tags 106 as the structured entries of users 20 are pre-categorized for easier tracking. Using the above structured data tags 106, the following is an additional list of possible revenue applications for system 10.

In another embodiment of system 10, regarding the how system 10 looks to users 20, the following provides some exemplary guidelines for the social media graphic user interface style and functionality (this refers to the GUI used in the regular interface 16).
User 20 information is going to be a timeline-driven sample of a user 20 life, with the ability to fast-forward and rewind—user 20 can see notches on a timeline, with comments, and also a lot of structured information/content 104: emotions, opinions, outlook, etc. . . . from prior posts 100.
The interface for system 10—the interactions for user 20 may be centered on a timeline—like a history of the human race—with the ability to zoom in on things (correlated with structured data tags 106) that happened in the past as well as to estimate/plot future events.
System 10 site has all of other social media's functionality, plus people are able for users 20 to cast their input—from mind and heart—thoughts and emotions, tagged by time and date—into system 10 in a structured way, which creates a structured environment, in which all sorts of reports can be run, patterns identified, highly supportable and accurate inferences made, and assumptions about future state/status/behavior posited.
There'll is a taxonomy of characteristics and associated structured tags 106, available to users 20, as a constantly expanding list, out of which people populate their profile; subordinate characteristics are at the bottom of the graph.
In one arrangement system 10 may be able to assist users 20, via the history of their structured posts, to: Phase I: get the gist of what's happening in their life; Phase II: infer patterns and provide results as actionable information to users 20, and Phase III: make predictions as to what could happen in the future.

In one embodiment of the system 10, regarding the security features of system 10, the following provides some exemplary privacy functionality.
Users 20 have fine-grained control of privacy, making themselves invisible, partially visible, fully visible. By default no one knows about the existence of a user 20, but user 20 can choose to share his/her success. Toggle switch: Public Life/Real Life.

Having described structured data tags 106 and consequent structured data 104 in some detail above, the following presents some additional features of system 10.

It is noted by applicant that structured data/content 104 may, as described above in conjunction with FIG. 3, essentially be any data entered in a well-specified format—e.g. a form, a multiple-choice question, a slider knob, etc. . . . associated with a structured tag 106. Unlike the most popular sites of today, on which posts are just entered as free-form text, possibly with a free form tagging, system 10 puts stress on data collection by means of controlled, category-driven data entry by user 20. For example, a way to capture your blood pressure may look like a barometer dial; user 20 can use their mouse or finger to move the dial hand. An entry for weight may look like scales, on which a user 20 either types in a number or move the hand on the scales with their mouse/finger/stylus.

In another arrangement, structured content 104 can be added to a post 100, linked to a structured tag 106 gesticulations could be a form of entering data 104. For example when users 20 go to a political rally, they shout and wave their hands which can act to enter positive or negative responses into a structured tag 106 for that rally. The ability to enter structured data 104 using gesticulations is discussed in more detail below.

Regarding what structured data tags 106 are available to which particular users 20, users 20 can create a portfolio of the facts you'd like to capture. System 10 has many predefined facts covering most aspects of human (and not just human) life. For example, if a user 20 is interested in health and fitness, user 20 fact categories (structured data tags 106) that they could store from system 10 to their profile would most likely be: “level of stress,” “body weight,” “calories consumed,” “calories expended,” “distance traveled,” etc. Users 20 interested in spiritual growth may want to log their dreams, sensations, epiphanies, meditation frequency, etc. . . .

System 10 can use such data for predictions. For example, how could system 10 know that in a user's 20 geographic area the headache level was at a record high on such and such a date, an hour after which an earthquake occurred? In prior art systems this would not work without extensive data mining, but the present system 10, because of the strictly structured data entries 104 through tags 106 can draw many statistics-based conclusions and use probability theory to try predicting future events.

Regarding how structured tags 106 are implemented and how users 20 initially approach system 10, users 20 can go to system's site (e.g. GUI 18) and register, either on a desktop/laptop or on your phone/tablet. The registration may be 100% anonymous. User 20 can then setup a user profile and decide whether their profile is visible or not.

After creating a profile, user 20 can organize their portfolios. A portfolio is a collection of facts that you want to capture; for example: your weight, your frustration/joyfulness level, etc. . . . System 10 enables different interests and states of being recorded through structured data tags 106, so there is a practically limitless number of facts to be followed. A User 20 can also specify a sub-profile for relatives, pets, computers and so on.

Once a user 20 has built a profile of facts, and maybe sub-profiles, user 20 can go to their dashboard (on local application on user's desktop/mobile device), where you see the timeline with notches that represent data-collection points. As noted above, structured data collection may be done using widgets—their appearance differs based on the facts selected. There are a few view perspectives—calendar-like, timeline-like, etc. . . . that allows user 20 to browse back and forth.

Based on the above system 10, using structured data 104 through structured tags 106 collects posts 100 from all of its users 20 and then easily correlates them providing significantly expanded correlation and information collection across a wide array of users 20.

Correlation of structured data 104 within system 10 works by finding relative changes among different fact reports grouped in time, or co-located in time (consequential). For that purpose system 10 uses statistical analysis, Markov chains, Bayesian inference and skews to see what happens or what might happen (in the future). As an example, in a prior art system the following messages are not correlated “Sweet! I'm on it” with “Madonna puzzled” with “DOW Jones dropped 500 points in 3 days.” In the present system, when the same messages 100 are sent out, but through structured data tags 106, this will look like: “Social/Hangout: +5; Mood: +5; “with “Rock/Singers/Madonna/Concert/NY Buffalo: yes”, “Wallstreet/DOW: −500”

In one embodiment, system 10 is expandable as an open API that allows other developers to create widgets and mobile applications that analyzes specific data (structured data 104) and post 100 events to system 10; e.g. a mobile pedometer application can track how many steps a user 20 took in a day and upload the number to system 10 at day's end as a post 100. System 10 tracks user's 20 weekly/monthly/annual walking activity.

In another arrangement, system 10 is configured for easy use by professionals/business. System 10 enables a “Vertical Module”—a kind of kit of facts, their taxonomies and analytical capabilities hand-crafted for particular business. So, if a user 20 asks about healthcare, system 10 may have a Cardiology Vertical module that clinics or individual providers (business users 20) may host in system 10 to draw more patients to their practices. Suppose exemplary user 20 “Johnny Appleseed” comes to an allergist and is being told that he now can go to some “allergy.practice.health.com” site and enter his sneezing prevalence over itching on daily basis using structured data tags 106. This may be in turn linked to pollen levels in the area because an “Allergology” module has special functionality for that. System 10 supports portal creation—a practitioner or clinic may host their own with custom branding and texts, the data goes into system 10 and is secure between the practitioner and his patient.

### Gesticulation Messages/Data:

In another embodiment of the invention, as outlined above, system 10 provides a unique social media platform that allows users 20 to communicate using structured posting 100 by allowing for structured data 104 entry, associated with structured tags 106 using user 20 gestures. For example, a user 20 may be enabled to use gesticulations to express feelings/emotions/etc. . . . and perform social interactions using body movements on various devices including mobile devices and phones.

To this end, in one embodiment of the present invention, APIs can be used to integrate with users' 20 devices. For example, system 10 provides an ability for devices like pulse meters, pedometers and the like to log data into the system through a well-defined open API. In fact, in some cases, such devices/API may in fact be utilized by generating automatic or scheduled (non manually initiated) posts 100 using structured data tags/data 106/104.

The use of various sensors is also contemplated to complement the social communication experience (WAVE). Mobile and computer devices have sensors that can provide additional input. Such sensors may include: microphone (loudness, pitch, spectral, and their differentials), gyroscope/accelerometer—gestures (WAVE), camera—gesture detection (WAVE).

Regarding the “WAVE” function, system 10 has the ability to utilize accelerometer, camera, microphone and other available sensors to detect gesticulations on a mobile device/computer (computer vision through webcam) as a means of expressive social communication. “Yo!, wave me brother!” A user 20 takes mobile phone, launches social chat app (for example) and performs a circular gesture—and that gets recognized by the system application on their phone and gets posted 100 as structured data entry 104 with a structured tag 106—WAVE=paradigm for social gesticulation communication. Wave's method is expressed by means of a gesticulation alphabet used by a social community to convey greetings, emotions, etc. similar to usage of smiley faces given in gesticulation expressions, each of which can be related to a pre-populated structured data tag.

Thus system 10 provides for a manner to generate structured data entries 104 or messages for the social media site of system 10 using only gesticulations or other body movements, for example as detective by sensors in the user's 20 mobile device. Such posts 100 generated in this manner, may either be at the manual initiation of users 20 or, as noted above, may simply be automatically generated (e.g. upon the movement of the device of user 20 when an API is active) or part of a non-manual scheduled posting 100 (e.g. based upon a set schedule that periodically generates a post 100 based on the movement of the device of a user according to a scheduled recording time).

It is understood that such a feature of system 10 may be used with either existing social media sites (i.e. one that employ existing unstructured data tags) or it may be used in conjunction with the features of structured data tags 106/structured data 104 as outlined in detail above.

For example, one aspect of the invention is to provide the ability to register user 20 gesticulations to generate social media messages. However, in another example, another aspect of the invention is to provide the ability to register user 20 gesticulations to generate social media messages but in the larger context of pre structured data tags 106. Thus, it is contemplated that a gesticulated motion may not only be used to generate a social media data/messages, but that certain types of gesticulations may be used to create social media data/messages that are further categorized with the context of pre-structured data tags 106.

Another embodiment of system 10 is to provide audio/voice-based controllers, applicable in gaming, social interactions and art creation as a manner for structured data entry. Although the use of audio and voice input for message/data/art creation is intended to be an independent feature of the invention, nevertheless, in one embodiment, such below described features may also be used in conjunction with the gesticulation features described above, as well as the structured data tags 106 to the extent such features overlap.

Audio-controlled interactions in connection with the structured data tag 106 looks at certain feature of a user's voice such as amplitude and spectrum to determine certain characteristics and generate voice posts 100 or voice shaped art posts 100 that can be likewise included in the larger structured data tag 106 environment.

### Amplitude

Instant Amplitude—can be analyzed in real time using simple EMA (Exponential moving average) filter based on [k] where [k] defines the width of sliding average window. In other words—by changing [k] can get instant amplitude vs. average amplitude.
Amplitude change pattern—an EMA function of first-order derivative of amplitude—may yield UP/DOWN trends.
Filtered signal Amplitude—a similar analysis but performed on a narrow-band filtered signal. May be used for things like “hiss” detection, or “wind/rumbling” detection without expensive frequency domain analysis. A filter may be implemented using simple harmonic oscillator based on Hook's law (F=−kx).
in each case, system 10 can be configured to receive posts 100 including structured data 104 associated with structure data tags 106 correlated to the voice amplitude changes of a user 20.

### Spectrum

FFT—analyze presence of certain frequency components in a signal.
Resonator Stack—pas a waveform through harmonic resonator stack that may detect resonance patterns.
Amplitude analysis of spectral components—may be used similar to amplitude analysis.
in each case, system 10 can be configured to receive posts 100 including structured data 104 associated with structure data tags 106 correlating to voice and input spectrum changes from the device of user 20.

The following is an extensive list of the various non-traditional data entry methods that can be employed by system 10 for receiving structured data 104 though structured tags.

### Temporal/Pattern/Vocal Gestures

System 10 may use temporal analysis which utilizes amplitude and spectral components and takes in consideration their values change over time, trying to identify/recognize a pattern. A typical application is vocal gestures. Vocal gestures may be phrases/sound patterns expressed by human users 20 that get recognized/associated with particular action/social representation.
Dynamic Time Warping—a technique for matching patterns in non-homogenous time scale based on amplitude/spectral envelope. For example, even if some vocal gesture is performed faster the amplitude envelope just stretches in time.
Markov Chains—probability distribution network that can be used for classification of patterns.
Bayesian Net—probability distribution network that can be used for pattern classification.
Neural Net—once reliable feature extraction methods for dissecting vocal inputs are determined, they can be supplied to a neural network to perform quick pattern recognition to reduce the CPU overhead associated with statistical analysis methods. This will provide an ability to derive detection of higher-order functions, such as sequencing of vocal gestures, or identification of vocal gestures in presence of noise.

### Controllers—Analogue

Analogue controllers supply continuous data in a form of at least 1 value that has a range of discreteness exceeding 5. They can be used to control games/entities on screen in real time.
Instant Amplitude—has a good value resolution depth (1000s of discrete levels), while being not computationally intensive (Android 1 core CPU ok).
Amplitude Change—has very shallow resolution (5-10 levels), good for things like “up/down”. Not computationally intensive. EMA (samples').
Singing Purity—Counts dominant frequencies in spectrum. The “better” the person sings the less secondary spectral spike are there. Has low depth of usable resolution—(10 levels).

Event—Events controllers basically just “happen” when some sound occurs.
Amplitude trigger—easy to implement—EMA over threshold is a trigger point. Easy on CPU.
Sing Up/Down—detects dominant frequencies inc/dec pattern. Moderately CPU hungry.
Filtered Amplitude Trigger—amplitude trigger after narrow band filter. Detect things like “Hiss,” “Rumble,” “Whistle,” “Blowing.”

### Pattern-Based Event

These controllers are the most CPU-intensive ones and convert audio input into Vocal Gestures (akin to speech recognition). The following are some exemplary use cases for using verbal gestures and other audio input for structured (or unstructured) message 100 entries in the present social media system 10.

### Vocal Gestures—

Vocal Gestures may be used in system 10 to communicate mood/trends by associating sound patterns with “social alphabet” of particular community/users 20. For example, a user 20 may go to a restaurant and be very satisfied with particular meal and express their feeling by tapping a “MIC” icon and saying some trending catch-phrase like “TA-i-AY-iAY-ST-iAYY!”—that will automatically product a structured post 100 in users' 20 account along with a location.

### Virtual Balloon Blowing—

Detection of the blowing sound in the microphone can be used in combination with singing to create and inflate virtual balloons of various shapes. The size of the balloon would be controlled by the intensity and duration of a blow.

### Voice-Shaped Art (VOSART!)

The present system 10 also allows users to quickly “draw” things on a virtual canvas using their vocal input as form of a structured post 100. Such drawings may be posted on via the present social media system and may likewise be included as posts 100 the system's 100 structured data tag 106 entries.

Landscape—System 10 can use audio controllers to draw landscapes by—
asking user 20 to “sing sky texture”—this will use spectral analysis to draw “haze-like” background with haze clarity/tint depending on sound controllers.
ask user 20 to sing clouds—now “spotty” babbling may appear as fractal patterns of white clouds on top of background.
ask user 20 to shape terrain by performing spectral analysis and building a terrain height map (similar to TERRAGEN).
ask user 20 to sing texture meshes per heightmap (one for meadows, another for snow peaks) for final rendering.
A final picture can be shared on system 10 and other linked accounts of user 20 on other social networks. This is enabled because the structured tags 106 can force data 104 to be entered in a readily and confined manner that can be translated into different image patterns (portions of patterns)

### Flowers—

A flower-creation application allows users 20 to create custom bouquets of flowers where flowers are “sung-on-canvas” in real time. An application of system 10 can have “flower plug-ins” (that can be purchased for a small fee) that interpret sound controllers while rendering various fractal graphical patterns in a form of flowers. For example: an amplitude content 104 may be used to draw individual flowers in a bouquet, while spectral characteristics control colors and shapes of flowers as specified by a flower plug-in that associates flower characteristics with the structured tags 106 though which content 104 is absorbed in the system/app.

Upon completion of “bouquet drawing” session, users may instantly share bouquets on other connected social media sites or on the social media site of system 10

### Garden—

A virtual world space may be hosted in the cloud where user 20 will “sing” to their flower gardens and maintain their “world profile” by constantly taking care of their space. Every flower will have a “soul”—a formula/data vector that can be created by user 20. Flowers can support growth and may require attention for growth. An attention can be given either by user 20 or by user's proxy. Users 20 may be able to add flowers to their spaces, get someone else's flowers and grow them in their spaces. The use of the flowers postings 100 may be included in the structured data 104 landscape as posts 100 related to mood.

### Virtual Farm—

Another application of these input methods entails raising and training virtual animals and plants (including flowers) by making their mood, behavior and appearance responsive to particular sounds of the owner/user 20, such as singing, whistling, blowing, etc. The application would display the overall happiness score in the farm, and the owner/user 20 would need to cheer his/her creations to maintain their high happiness score, which goes down unless each creation is stimulated. Users 20 can exchange their creations, and learn to stimulate/grow them in their own or others' farms. As with flowers, the use of the virtual farm postings may be included in the structured data 104 landscape as posts 100 related to mood.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A system for implementing data postings in a social media platform, said system comprising:
an interface configured to allow users to receive messages from and to post messages to said system;
a processor configured to provide a plurality of structured data tags for use by said users, said structured data tags having at least one data field for correlating at least one structured data entered in conjunction with said structured data tag;
wherein said system in configured to receive a plurality of communications from said users which include at least one structured data tag and at least one correlated structured data.

2. The system as claimed in claim 1, wherein said communications include a plurality of structured data tags each having an associated structured data.

3. The system as claimed in claim 1, wherein said system is configured to organize said structured data associated with at least one structured data tag from a plurality of communications from at least one of said users to generate a history said structured data of said user.

4. The system as claimed in claim 1, wherein said system is configured to organize said structured data associated with at least one structured data tag from a plurality of communications from a plurality of users to generate a metric of structured data from posts of said plurality of users under correlated to said structured data of said user.

5. The system as claimed in claim 1, wherein said communications includes at least two separate structured data tags, said communications including at least one separate include structured data associated with at least two separate structured data tags.

6. The system as claimed in claim 1, wherein said communications to said system from said users are via a mobile device.

7. The system as claimed in claim 6, wherein said system is configured to allow said users to enter said structured data, correlated to said structured data tag, using gesticulations including movement of said mobile device.

8. The system as claimed in claim 7, wherein said gesticulations including movement of said mobile device, automatically generate a communication to said system including a said structured data in conjunction with a said structured data tag.

9. The system as claimed in claim 7, wherein said gesticulations including movement of said mobile device, generate a communication to said system based on a scheduled time initiation, said communication including a said structured data in conjunction with a said structured data tag.

10. The system as claimed in claim 6, wherein said system is configured to allow said users to enter said structured data, correlated to said structured data tag, using a widget included in a GUI (Graphic User Interface) that facilitates entering of said structured data in a manner that correctly correlates to required fields for said associated structured data tag.
